(19) United States
(12) Patent Application Publication
(10) Pub. No.: US 2012/0182112 A1
(43) Pub. Date: Jul. 19, 2012

(54) TRANSFORMER

(75) Inventors: Chih-Ping Lu, Zhubei City (TW); Chih-Shen Chiang, Zhubei City (TW)

(73) Assignee: LOGAH TECHNOLOGY CORP.

(21) Appl. No.: 13/431,979

(22) Filed: Mar. 28, 2012

Related U.S. Application Data
(63) Continuation-in-part of application No. 13/087,218, filed on Apr. 14, 2011, now abandoned.
Application No. 13/087,218 is a continuation-in-part of application No. 12/616,622, filed on Nov. 11, 2009, now abandoned.

(51) Int. Cl. H01F 27/29

(52) U.S. Cl. 336/192

(57) ABSTRACT

An improved transformer is disclosed. The transformer of the present invention includes a main body. The main body has a primary winding partition, several secondary winding partitions and two end portions. Several leads are disposed in either end portion. A sloped wire-guiding groove is provided in a vertical wall of the primary winding partition and may guide the winding in the primary winding partition. The width of the sloped wire-guiding groove is slightly greater than that of the wire to avoid the rupture of the wire.

### CROSS REFERENCES RELATED TO THE APPLICATION

This application is a continuation-in-part of U.S. patent application Ser. No. 13/087,218 filed on Apr. 14, 2011, which is a continuation-in-part of U.S. patent application Ser. No. 12/616,622 filed on Nov. 11, 2009.

### BACKGROUND OF THE INVENTION

1. Field of the Invention

The invention generally relates to a transformer. More particularly, the invention relates to a transformer, in which the bending of the wire may be reduced and the wires are allowed to run closely and neatly on the surfaces of the main body. Therefore, breakage may be avoided and quality of the transformer may be improved.

2. Description of the Prior Art

The coil type transformer has been around for more than 100 years. Many improvements and modifications have been made to improve the coil type transformer. Despite these improvements and modifications, the coil type transformer operates according to the same physical principle, mutual induction.

In the coil type transformer, mutual induction occurs if an emf is induced in a coil because of current changes in a second coil. A primary coil and the secondary coil are wound around the same iron core. The primary coil is connected to the source of electrical energy and the secondary coil is connected to a load. When ac is applied to the primary coil, changes in magnetic flux would occur in the iron core and the changes would cause an ac with the same frequency in the secondary coil. The ratio of primary voltage (or emf) to secondary voltage (or emf) is in proportional to the ratio of the number of turns on the primary coil to the number of turns on the secondary coil. Therefore, if the number of turns on the secondary coil is more than the number of turns on the primary coil, the output voltage is greater than the input voltage and it is called a step-up transformer; conversely, if the number of turns on the secondary coil is less than the number of turns on the primary coil, the output voltage is less than the input voltage and it is called a step-down transformer.

Therefore, coils are the most important parts of the coil type transformer. In addition to the quality of the wires, how winding is done is quiet important. Please see FIG. 4, which is a bottom view illustrating the secondary winding in the transformer of the prior art. The transformer has a main body 3. The main body 3 has a primary winding partition 31 and several secondary winding partitions 32. A secondary wire 42 is wound around the core on the secondary winding partitions 32. One end of the secondary wire 42 passes the primary winding partition 31 and the primary end piece 311 and then is connected to one of several primary leads 312. Next, the primary wire 41 is wound around the iron core on the primary winding partition 31.

The aforementioned secondary wire 42 is usually a very thin wire; therefore, if the winding of the secondary wire 42 is not done meticulously, the secondary wire 42 is prone to breakage and short circuit. As the secondary wire 42 runs from the primary lead 312 to the primary end piece 311, because of the difference in height between the primary lead 312 and the primary end piece 311, the secondary wire 42 tends not to rest closely to the surface of the primary end piece 311 and is prone to the breakage caused by the edge of the primary end piece 311. Such breakage may lead to the disconnection of the wire. Moreover, the primary lead 312 is usually a thin metal piece and is prone to deformation and breakage if it is pulled by the wire 42 or is bumped by an external force; in such case, quality of the transformer suffers.

In addition, as previously mentioned, because the secondary wire 42 tends not to rest closely to the surface of the primary end piece 311, the wire 42 is prone to bending and breakage after the primary wire 41 is wound on top of the wire 42. Such bending and breakage leads to the damage of the transformer.

From the above, we can see that the transformer of the prior art has many disadvantages and drawbacks and needs to be improved.

To eliminate the disadvantages of the transformer of the prior art, the inventor has put a lot of effort into the subject and has successfully come up with the improved transformer of the present invention.

### SUMMARY OF THE INVENTION

An object of the present invention is to provide a transformer in which a rubber piece is fitted on at least one surface of one of several primary leads to strengthen the primary lead and to avoid the bending and breakage of the primary lead so that the transformer may have a longer service life.

Another object of the present invention is to provide a transformer. The rubber piece is fitted on at least one surface of one of several primary leads on the transformer. The rubber piece provides the buffer action, and it makes the secondary wire of the transformer which is pulled from several primary leads run closely and automatically fitted on the surface of the rubber piece and the primary end piece. The transformer used the rubber piece as buffer to avoid bending and breakage.

A third object of the present invention is to provide a transformer in which a wire-guiding groove is formed in the primary end piece to guide the secondary wire to run closely and neatly on the lower surface of the primary winding partition. Therefore, quality of the transformer may be improved.

To reach these objects, the improved transformer of the present invention is disclosed. The improved transformer of the present invention comprises a main body, at least a rubber piece and a wire-guiding groove. The main body has a primary winding partition, several secondary winding partitions and two end portions. Several leads are disposed in either end portion. One end of the secondary wire goes from the primary lead to the primary end piece and the primary winding partition. The rubber piece is fitted on at least one surface of one of several primary leads. The rubber piece can strengthen the primary lead. The rubber piece provides the buffer action, and it makes the secondary wire of the transformer which is pulled from several primary leads run closely and automatically fitted on the surface of the rubber piece and the primary end piece. The transformer used the rubber piece as buffer to avoid bending and breakage. A wire-guiding groove is formed in the primary end piece to guide the secondary wire to run closely and neatly on the lower surface of the primary winding partition. As the secondary wire goes from the primary lead to the primary end piece, the rubber piece enables the secondary wire to run closely and neatly on the surface of the rubber piece and primary end piece to avoid the breakage caused by the edge of the primary end piece. Also, the wire-guiding groove enables the secondary wire to run closely and neatly on the lower surface of the primary winding partition before the secondary wire reaches the secondary winding partitions. Therefore, quality and durability of the transformer may be improved or enhanced.

A wire-storing groove is provided around the primary end piece to store the extra winding and to avoid layer short-circuit, a sloped groove is provided in at least one surface of the primary winding partition and may guide the winding in the primary winding partition. The width of the sloped groove is wider than the width of the wire, wherein the leading part of the wire is winded on the sloped groove first and then the following parts of the wire are winded on the primary winding partition so as to avoid the following part of the wire being compressed onto the leading part of the wire and fracturing the leading part of the wire.

One or more partitions are provided in the primary and secondary winding partitions. A slot may be provided on each partition to allow the passage of the wire from one partition into another partition.

### BRIEF DESCRIPTION OF THE DRAWINGS

FIG. 1 is a perspective view illustrating the main body of the improved transformer of the present invention.

FIG. 1A is an enlarged view illustrating a primary lead fitted with a rubber piece in the improved transformer of the present invention.

FIG. 2 is a perspective bottom view illustrating the main body of the improved transformer of the present invention.

FIG. 2A is an enlarged view illustrating a primary lead fitted with a rubber piece in the improved transformer of the present invention.

FIG. 3 is a bottom view illustrating the secondary winding in the improved transformer of the present invention.

FIG. 4 is a bottom view illustrating the secondary winding in the transformer of the prior art.

FIG. 5 is a perspective view illustrating the main body of the improved transformer of the present invention.

### DETAILED DESCRIPTION OF THE PREFERRED EMBODIMENT

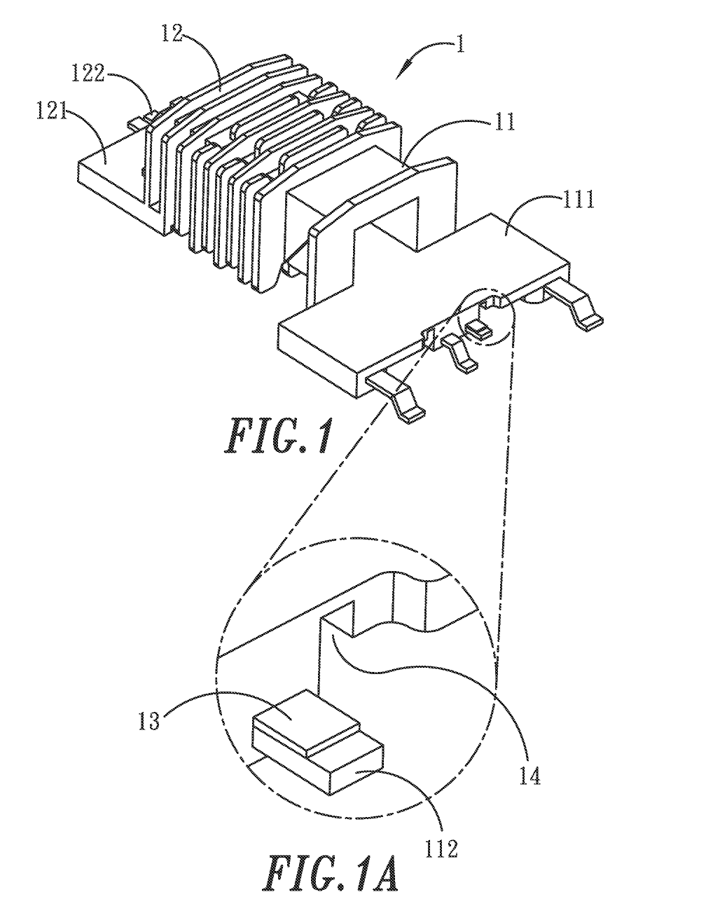

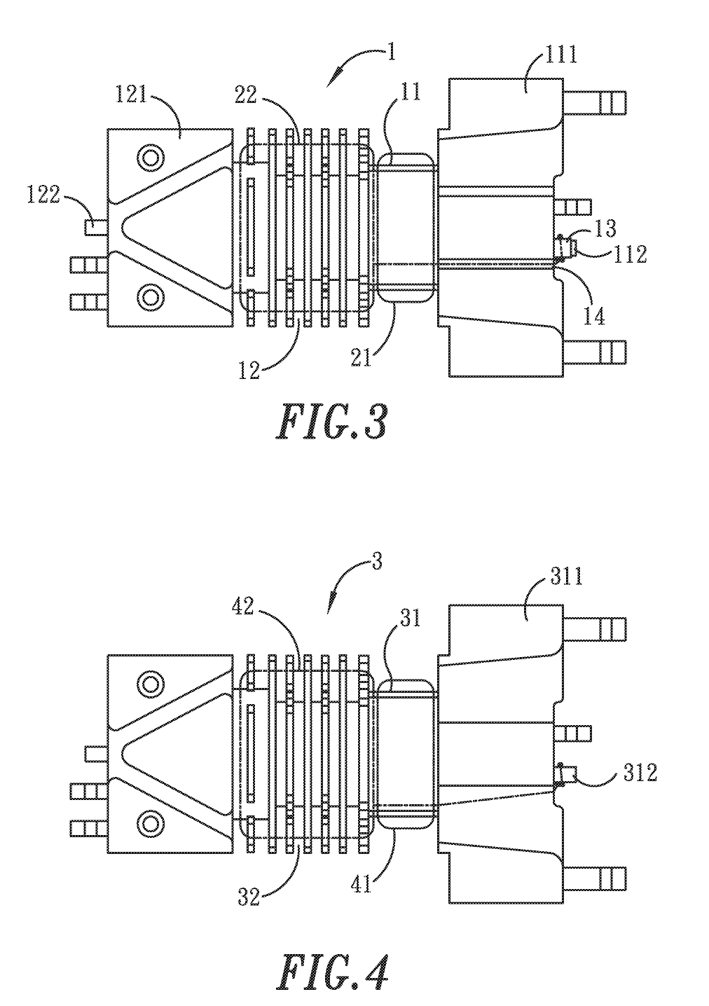

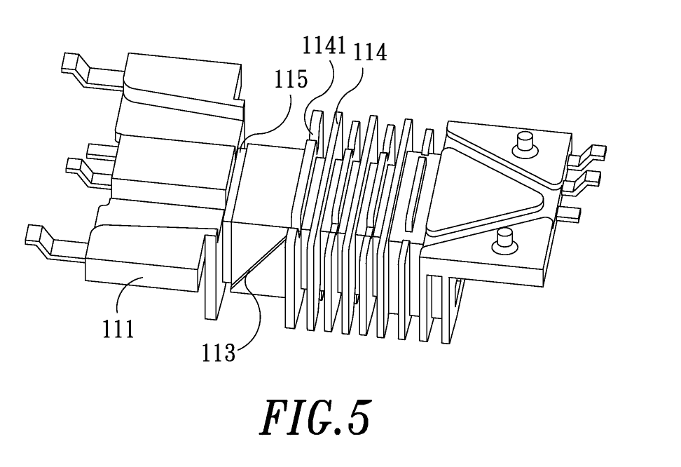

Please refer to FIGS. 1 to 3, which illustrate the improved transformer of the present invention. The improved transformer of the present invention comprises a main body 1, at least a rubber piece 13 and a wire-guiding groove 14. A primary winding partition 11 and several secondary winding partitions 12 are formed on the main body 1. A primary winding/wire 21 is wound around the iron core on the primary winding partition 11 and a secondary winding/wire 22 is wound around the iron core on the secondary winding partitions 12. One end of the secondary wire 22 goes to a primary end piece 111, which is disposed by the primary winding partition 11, and then is connected to one of several primary leads 112. Next, the primary wire 21 is wound around the iron core on the primary winding partition 11.

The key point of the present invention is the rubber piece 13 fitted on at least one surface of one of several primary leads 112. The rubber piece 13 can strengthen the primary lead 112. Because of the rubber piece 13 as buffer, the rubber piece 13 reduces the falling head between the primary lead 112 and the primary end piece 111. In addition, as the secondary wire 22 goes from the primary lead 112 to the primary end piece 111, the rubber piece 13 enables the secondary wire 22 to run closely and neatly on the surface of the rubber piece 13 and primary end piece 111 to avoid the breakage caused by the edge of the primary end piece 111.

In the same manner, the rubber piece 13 may be fitted on at least one surface of one of several primary leads 122.

In addition, a wire-guiding groove 14 is formed in the primary end piece 111. The wire-guiding groove 14 can guide the secondary wire 22 when the secondary wire 22 runs from the secondary winding partitions 12 to the primary winding partition 11 and the primary end piece 111 to reduce the bending of the secondary wire 22 and to keep the secondary wire 22 running closely and neatly on the lower surface of the primary winding partition 11. Therefore, the wire-guiding groove 14 can guide the passage of the secondary wire 22 through the primary winding partition 11. Similarly, the wire-guiding groove 14 may be formed in the secondary end piece 121.

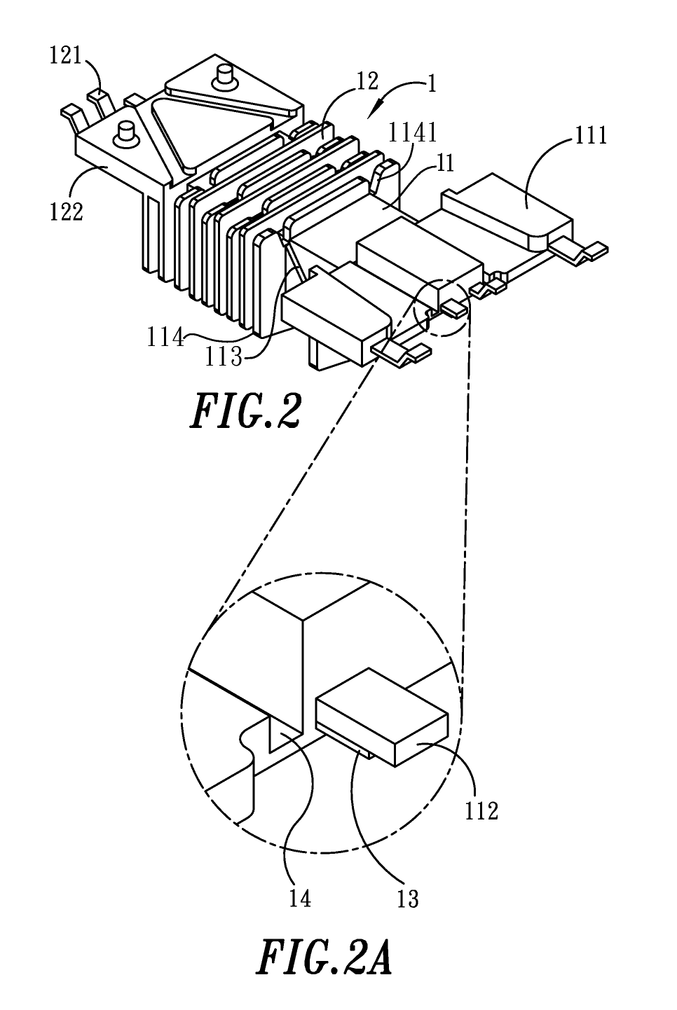

Please refer to FIGS. 2 and 5. A wire-guiding groove 14 is formed in the primary end piece 111. A wire-storing groove 115 is provided around the primary end piece 111 to store the extra winding and to avoid layer short-circuit. A sloped groove 113 is provided in at least one surface of the primary winding partition 11 and may guide the winding in the primary winding partition 11. The width of the sloped groove 113 is wider than the width of the wire, wherein the leading part of the wire is winded on the sloped groove first and then the following parts of the wire are winded on the primary winding partition so as to avoid the following part of the wire being compressed onto the leading part of the wire and fracturing the leading part of the wire.

One or more partitions 114 are provided in the primary winding partition 11. A slot 1141 may be provided on each partition 114 to allow the passage of the wire from one partition into another partition.

The sloped groove 113 and the wire-storing groove 115 may be provided on the primary winding partition 11 or the secondary winding partitions 12 to avoid the layer short-circuit of the winding.

In comparison to the transformer of the prior art, the improved transformer of the present invention has the following advantages:

1. The improved transformer of the present invention has a higher quality and a longer service life because the secondary wire is not prone to bending and breakage caused by the edge of the primary end piece.

2. In the improved transformer of the present invention, the quality and stability may be improved because the bending of the secondary wire may be reduced and the secondary wire may run closely and neatly on the lower surface of the primary winding partition when the secondary wire runs from the secondary winding partitions to the primary winding partition.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

What is claimed is:

1. A transformer, comprising:
a main body, having a primary winding partition, several secondary winding partitions and two end portions, and several leads are disposed in either end portion,
wherein a wire-storing groove is provided around the primary end piece to store the extra winding and to avoid layer short-circuit, a sloped groove is provided in at least one surface of the primary winding partition and guide a wire winding in the primary winding partition, wherein the width of the sloped groove is wider than the width of the wire, wherein the leading part of the wire is winded on the sloped groove first and then the following parts of the wire are winded on the primary winding partition so as to avoid the following part of the wire being compressed onto the leading part of the wire and fracturing the leading part of the wire.

2. The transformer as in claim 1, wherein one or more partitions are provided in the primary and secondary winding partitions and a slot may be provided on each partition to allow the passage of the wire from one partition into another partition.
